(19) United States
(12) Patent Application Publication
(10) Pub. No.: US 2006/0095865 A1
(43) Pub. Date: May 4, 2006

(54) Dynamic graphical user interface for a desktop environment

(76) Inventor: Mohamed A. Rostom, Calgary (CA)

Correspondence Address: DARBY & DARBY P.C., P. O. BOX 5257, NEW YORK, NY, 10150-5257, US

(21) Appl. No.: 10/982,760

(22) Filed: Nov. 4, 2004

(51) Int. Cl. G06F 17/00; G06F 3/00

(52) U.S. Cl. 715/810; 715/779

(57) ABSTRACT

A graphical user interface (GUI) for a computer desktop environment that provides access to a plurality of services through a menu that is displayed in a large portion of the desktop environment independent of a taskbar. The menu comprises one or more icons arranged in a pattern and that represent application programs, access to configuration settings, access to data files, and/or access to a submenu. A submenu comprises one or more images arranged in a pattern relative to an associated icon and represent additional services and/or further menu levels. A submenu is displayed when a user hovers a cursor over the associated icon or with other indications. A system configuration cache defines relationships between menu levels and points to graphic data comprising the menu and submenus. A menu manager controls interaction with the menu and enables desktop shortcuts to be toggled on and off.

### FIELD OF THE INVENTION

The present invention is directed to a graphic user interface (GUI), and more specifically to a GUI using dynamically fanning tabs for a computer desktop environment.

### BACKGROUND OF THE INVENTION

Current computer desktop GUIs typically include a desktop space where icons are displayed to represent programs, data, and other available software items. The desktop space is generally a large portion of a total display area, so there is room for a relatively large number of icons. Each icon is usually associated with an individual program or a specific feature of a program. To access further features and options of a program, a user generally must select and activate a corresponding icon, such as by double clicking on the icon, and then navigate to other options within the program.

Current desktop GUIs also typically provide a taskbar in the form of a relatively thin graphical strip located along an edge of the desktop environment. A user can select a graphical button, such as a START button, within the taskbar to navigate through a menu structure for access to programs, settings, and other software items. Taskbar navigation is generally performed through pop-up or drop-down menus that are visually connected to the taskbar, but extend beyond the boundaries of the taskbar. The pop-up or drop-down menus are needed, because the area of the taskbar is generally limited to the thin strip along one edge of a display. The pop-up or drop-down menus may be nested several layers deep. Each nested layer of the menu structure is typically displayed as a separate pop-up or drop-down menu in a rectangular image that is visually connected to a previous layer of the menu structure. Each nested layer also often includes small icons to represent a next layer or a software item. Many of the software items of the nested menus are accessible through an icon placed in the desktop space by the user. Thus, the desktop icons and the taskbar menus are somewhat duplicative.

### BRIEF DESCRIPTION OF THE DRAWINGS

FIG. 1 shows a functional block diagram of an exemplary computing device according to one embodiment of the invention;

FIG. 2 is a functional block diagram illustrating an overall architecture of an exemplary embodiment of the present invention;

FIG. 3 is a screen print illustrating a centrally circular menu in a desktop environment according to an exemplary embodiment of the present invention;

FIG. 4 is screen print illustrating circularly fanned tabs of software options associated with a selected icon in the exemplary desktop environment of FIG. 3;

FIG. 5 is a screen print illustrating a side curved menu in a desktop environment according to another exemplary embodiment of the present invention;

FIG. 6 is screen print illustrating elliptically fanned tabs of software options associated with a selected icon in the exemplary desktop environment of FIG. 5;

FIG. 7 is a flow diagram illustrating overall logic controlling interaction with a menu according to an exemplary embodiment of the invention;

FIGS. 8A and 8B are a flow diagram illustrating logic of a menu management process according to an exemplary embodiment of the invention; and

FIG. 9 is a flow diagram illustrating logic of a shortcuts process according to an exemplary embodiment of the invention.

### DETAILED DESCRIPTION OF THE INVENTION

The present invention will now be described with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely software embodiment, an entirely hardware embodiment or an embodiment combining software and hardware aspects. The following detailed description is, therefore, not to be taken in a limiting sense.

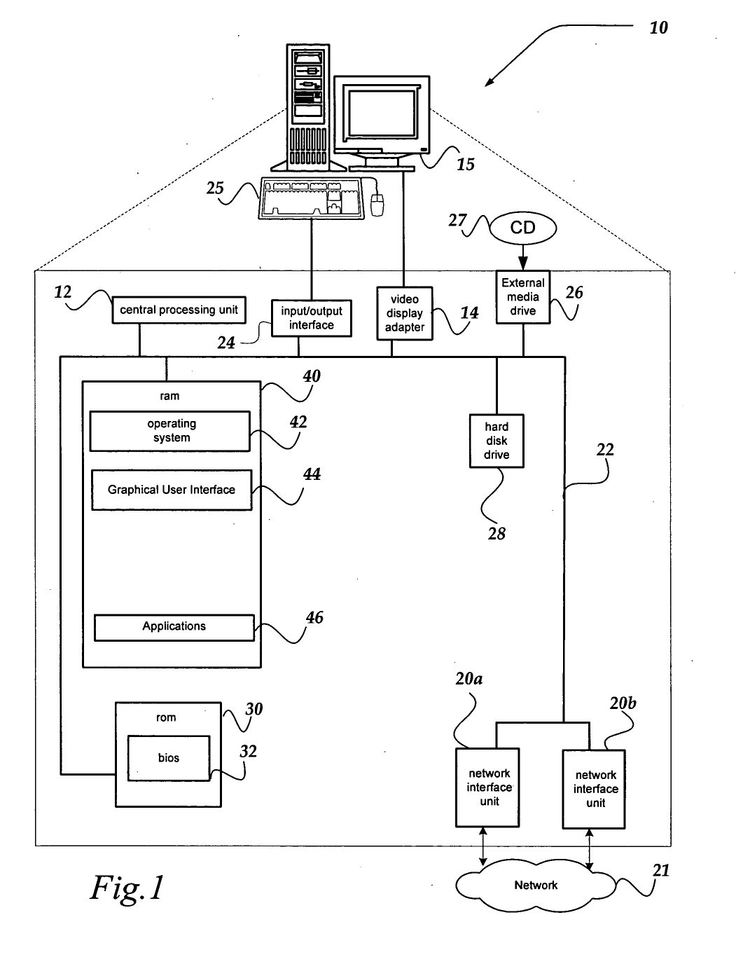

Throughout the specification, the term “coupled,” or “in communication with” means a direct connection between the things that are connected, or an indirect connection through one or more either passive or active intermediary devices or components. The meaning of “a,” “an,” and “the” include plural references. The meaning of “in” includes “in” and “on.” Briefly stated, the invention is direct to a method and system for providing a graphical user interface that enables dynamic access to various levels of software features and options through multiple icons that are provided over the entire desktop environment without limitation by a toolbar area. FIG. 1 shows a functional block diagram of an exemplary compute 10, according to one embodiment of the invention. Computer 10 may include many more components than those shown. The components shown, however, are sufficient to disclose an illustrative embodiment for practicing the invention. In an exemplary embodiment, computer 10 comprises a client device such as, but not limited to, personal computers (PCs), PDAs, mobile terminals (e.g., cell phones), servers, and the like.

Computer 10 includes a processing unit 12, a video display adapter 14 that can drive a display 15, and a mass memory, all in communication with each other via a bus 22. The mass memory generally includes RAM 40, ROM 30, and one or more permanent mass storage devices, such as an external media drive 26 that can read a machine readable medium such as a CD 27, a hard disk drive 28, a tape drive, and/or a floppy disk drive. The mass memory stores an operating system 42 for controlling the operation of computer 10. Any general-purpose operating system may be employed. A basic input/output system (“BIOS”) 32 is also provided for controlling low-level operation of computer 10.

The mass memory also includes computer-readable media, such as volatile, nonvolatile, removable, and non-removable media implemented in any method or technology for storage of information, such as computer readable instructions, data structures, program modules, or other data. Examples of computer-readable media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computing device.

The mass memory also stores program code and data. One or more applications 48 are loaded into mass memory and run on operating system 42. Examples of application programs include database programs, schedulers, transcoders, email programs, calendars, web services, word processing programs, spreadsheet programs, and so forth. Mass storage may further include applications such as a graphical user interface 44, which will be discussed in further detail below.

Computer 10 also includes input/output interface 24 for communicating with external devices, such as a keyboard, mouse, scanner, or other input devices 25. Computer 10 can communicate with the Internet, a telephone network, a postal network, or some other communications network via one or more network interfaces such as network interface units 20a and 20b, which are constructed for use with various communication protocols including transmission control protocol/Internet protocol (TCP/IP), user datagram protocol (UDP), code division multiple access (CDMA), time division multiple access (TDMA), global system for mobile communications (GSM), Institute for Electrical and Electronics Engineers (IEEE) 802.11, IEEE 802.16 (WiMax), SMS, general packet radio service (GPRS), Wireless Application Protocol (WAP), and the like. Network interface units 20a and 20b are sometimes known as transceivers, transceiving devices, network interface cards (NICs), and the like. The network interface units can facilitate communications between computing devices that conform to the same or differing communication protocols. For example, network interface units 20a and 20b are illustrated as communicating with a network 21, such as the Internet. Network 21 provides communication services for conforming server and/or client devices, such as a server.

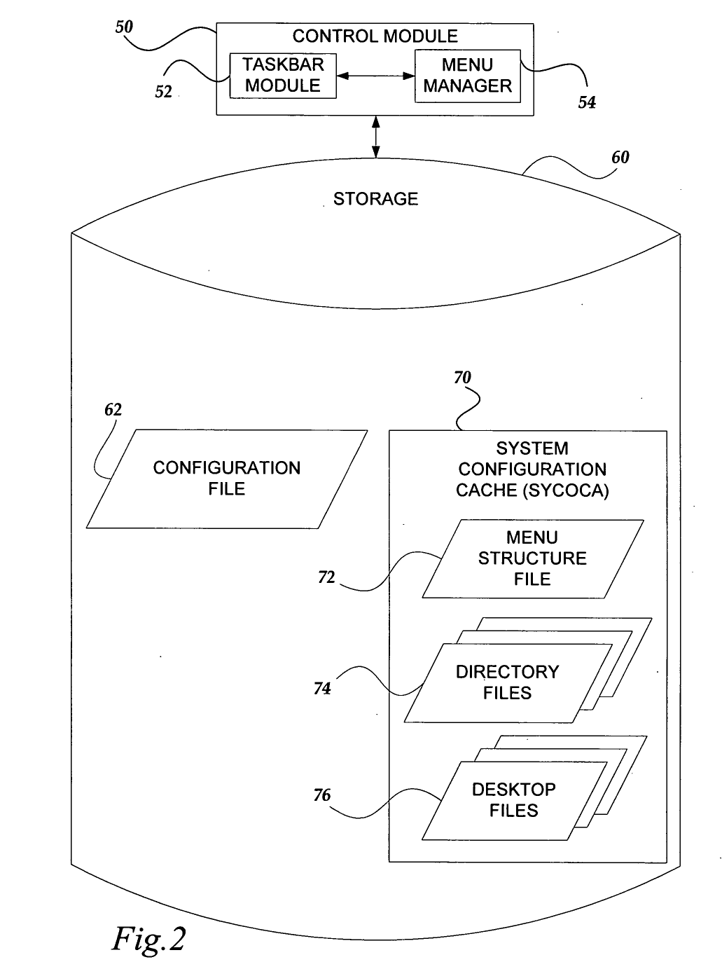

FIG. 2 is a functional block diagram illustrating an overall architecture of an exemplary embodiment of the present invention that provides a dynamic GUI. A control module 50 controls the GUI and communication with an operating system kernel. Operating system communication can be implemented in a conventional manner such as that used by a kicker module of the Linux™ based K Desktop Environment (KDE), and the like. Control module 50 includes a taskbar module 52 that provides desktop information and services through a graphical strip along one edge of a display. Some of the desktop information includes a clock and a system tray of small icons representing services that are running in the background. Other desktop information includes graphical tile buttons that represent currently running foreground services and enable a user to switch between windows of the foreground services.

A conventional taskbar also usually includes a small “Start” graphical button that enables a user to navigate a pop-up menu to a desired program or other service. These conventional pop-up menus usually remain visually tied to the small Start button in the taskbar and the pop-up menus are generally rectangular. The services available through a conventional taskbar pop-up menu are typically illustrated as small icons followed by a short title so as to minimize the display space taken up by the pop-up menu. The small icons and text can sometimes be difficult to read. Access to the services can also be duplicated with larger shortcut icons on a larger area of the desktop environment so that the user can quickly access a service without having to navigate through the pop-up menu. Multiple shortcut icons can clutter the desktop area, making it more difficult to use the desktop environment. The shortcut icons usually persist in the desktop area unless deleted from the desktop area.

Taskbar module 52 does not need to keep a pop-up menu visually tied to a start button in the taskbar. Instead, taskbar module 52 provides a menu activation button that enables a user to initiate a menu that is free from the taskbar and utilizes the larger area of the desktop. Larger shortcut icons need not be duplicated in the larger area of the desktop environment, although shortcut icons can still be used in the desktop environment. To initiate the menu, taskbar module 52 communicates a command to a menu manager 54, which displays and controls interaction with the menu.

Menu manager 54 communicates with a storage 60 that includes a configuration file 62 for storing screen location, graphic file names and/or address, color information, lighting information, and other visual data associated with menu elements to be displayed. Menu elements include a menu background, menu icons, submenu tabs, and other visual elements. Each menu element has a unique identifier, sometimes referred to as a key. The key is used to associate a menu element with a portable network graphic (png) file (or other graphic file), with screen location coordinates, with lighting enhancements, and with other visual data. When menu elements move within the display area, changes to the location data and other visual data are stored relative to each corresponding key in configuration file 62.

Storage 60 also includes a system configuration cache (sycoca) 70, which stores functional information about the menu. Some of the menu elements comprise icons that are associated with a submenu or an application program (or other data service). The relationships between the icons and the submenus and/or services are defined by a menu structure file 72. An exemplary embodiment of menu structure file 72 is an extensible markup language (XML) file, which includes pointers that associate each icon (e.g., each icon key) with data for a corresponding submenu or with a service.

Data for a submenu is stored in a directory file 74. The data includes keys to identify tabs that will be displayed to visually illustrate the submenu. Each key is associated with a pointer to a png file that defines the graphical image of the tab. Similarly, each key can point to a string of text that will be displayed over the tab. Position, color, lighting, and other data for each tab can also be stored in the directory file, or in the configuration file.

Data for an application program, a data file, or other computing service is stored in a desktop file 76. A desktop file includes keys of those icons and submenu tabs that do not lead to further submenus, and instead are associated with executable code or other final data. Accordingly, desktop file 76 includes pointers to, and/or parameters for, corresponding programs, data files, or other services. Menu manager 54 can use this data to instruct an underlying operating system kernel to initiate a corresponding program, to access a data file, control a peripheral device, communicate through a network, and/or perform another service.

Screen Displays

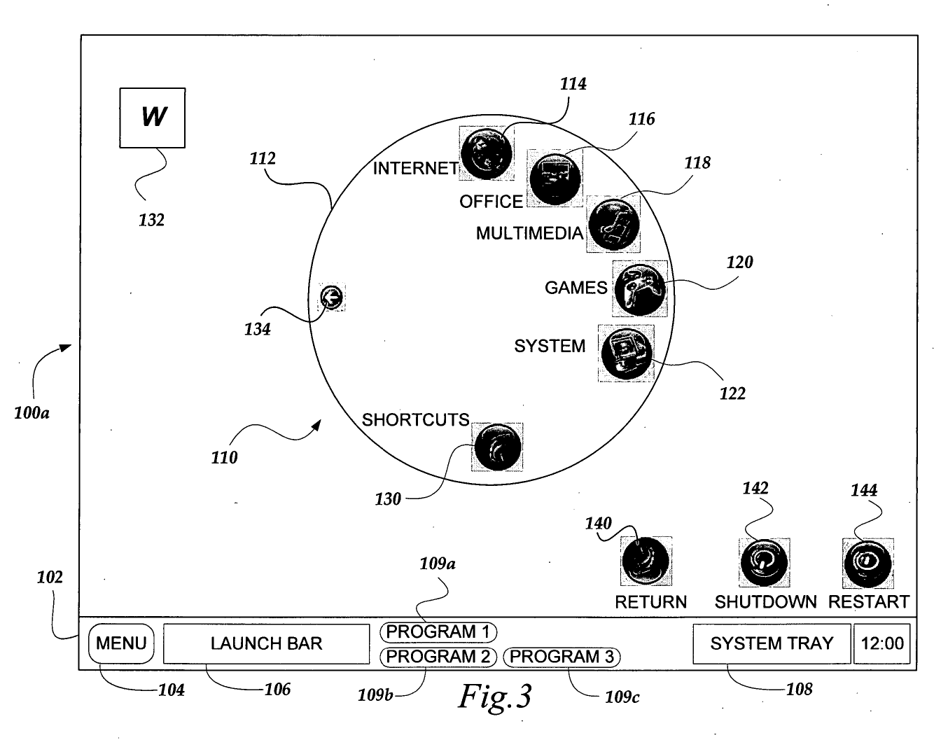

An example menu is shown in FIG. 3 as a centrally circular menu 110 in a desktop environment 100a according to an exemplary embodiment of the present invention. Centrally circular menu 110 is activated and displayed when a user left clicks on a menu activation button 104 within a taskbar 102. As indicated above, taskbar 102 can also include other elements such as a launch bar 106 of icons for immediately launching a program, and a system tray 108 identifiing background services. The taskbar can further include tile buttons 109a-109c for minimizing, maximizing, and/or switching focus between foreground services such as application programs.

Centrally circular menu 110 comprises a number of menu elements, including a circular background area 112 that is displayed in a central portion of desktop environment 100a. Within circular background area 112 are a plurality of service icons 114-122. Each service icon represents a service or a submenu that leads to other services or additional submenus. Also within circular background area 112 are display control icons 130 and 134. A shortcuts control icon 130 enables a user to toggle display of shortcut icons, such as a shortcut icon 132, in the desktop area outside of circular background area 112. A menu location control icon 134 enables the user to move centrally circular menu 110 to another location in the display area. The menu can be moved to a left, right, top or bottom location. Alternatively, the menu can be dragged to any arbitrary location in the desktop environment.

Centrally circular menu 110 can also include one or more termination icons 140-144. Alternatively, the termination icons can be displayed separate from the menu as illustrated in FIG. 3. In yet another embodiment, the termination icons can be displayed in and controlled through the taskbar. In any case, a return icon 140 enables a user to terminate execution of the desktop GUI and return to an underlying operating system environment, such a command line operating system environment, a Microsoft Windows™ operating system environment, and the like. A shutdown icon 142 enables the user to terminate execution of the desktop,GUI and power down the computing device. A restart icon 144 enables the user to terminate and restart execution of the desktop GUI.

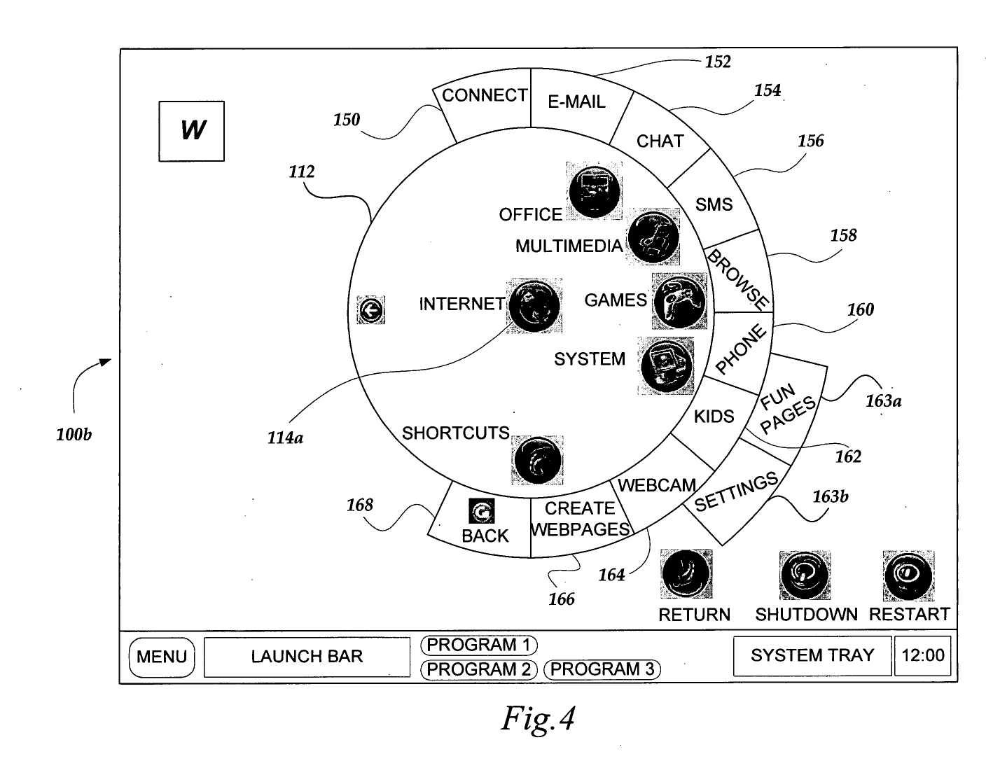

FIG. 4 is a screen print illustrating a desktop environment 100b with circularly fanned tabs 150-168 of software services and/or submenus that are associated with a selected service icon in the exemplary desktop environment of FIG. 3. For example, when a user moves a cursor over internet icon 114 shown in FIG. 3, the internet icon is moved to the center of menu background 112, as shown in FIG. 4 by internet icon 114a. The relocation of internet icon 114a can be instantaneous, performed with an animation, or accomplished with other audio/visual techniques. Detection of the cursor over the internet icon also causes circularly fanned tabs 150-168 to be displayed around the perimeter of menu background 112. The circularly fanned tabs can be displayed with animation, colors, lighting, and other visual effects. The user can then left click on one of the fanned tabs to initiate a corresponding service. If a fanned tab simply represents a group of services, moving the cursor over that fanned tab will initiate display of an outer level of tabs that represent a submenu of services. For instance, if the cursor is moved over a kids tab 162, outer level tabs 163a and 163b are displayed to provide access to another menu level and/or an executable service. A back tab 168 enables the user to remove a level of tabs or return focus to the service icons.

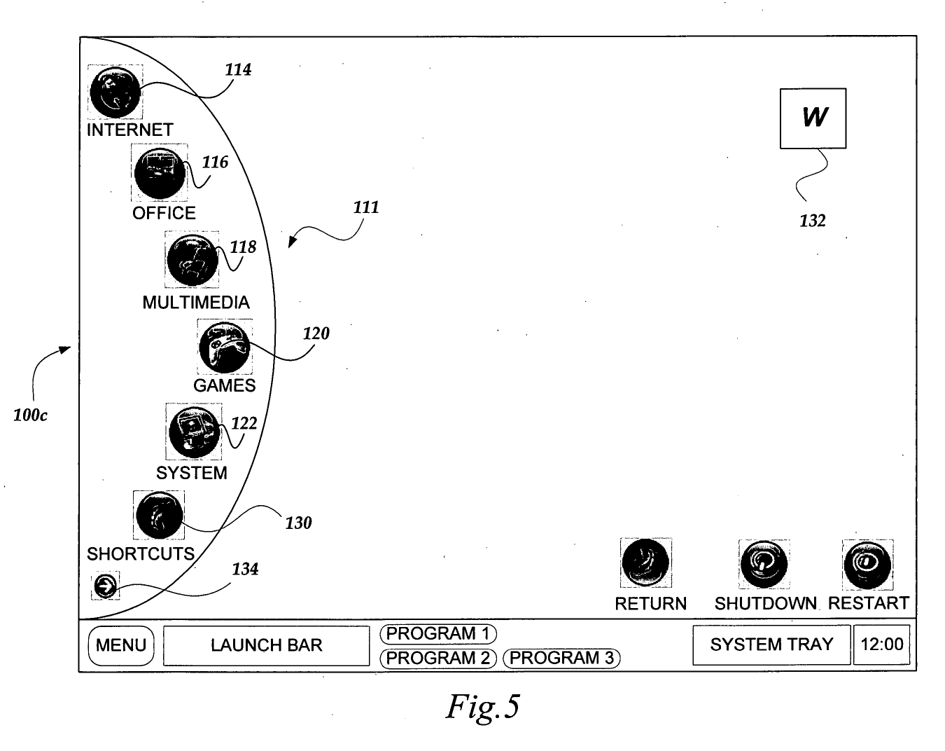

FIG. 5 is a screen print illustrating a desktop environment 100c that displays a side curved menu 111 resulting from a user activating menu location control icon 134 to move the menu to the left portion of the desktop environment. In this case, service icons 114-122 are arranged in a curve at the left along with display control icons 130 and 134. Shortcuts, such as shortcut 132, can be relocated as a result of moving the location of the menu.

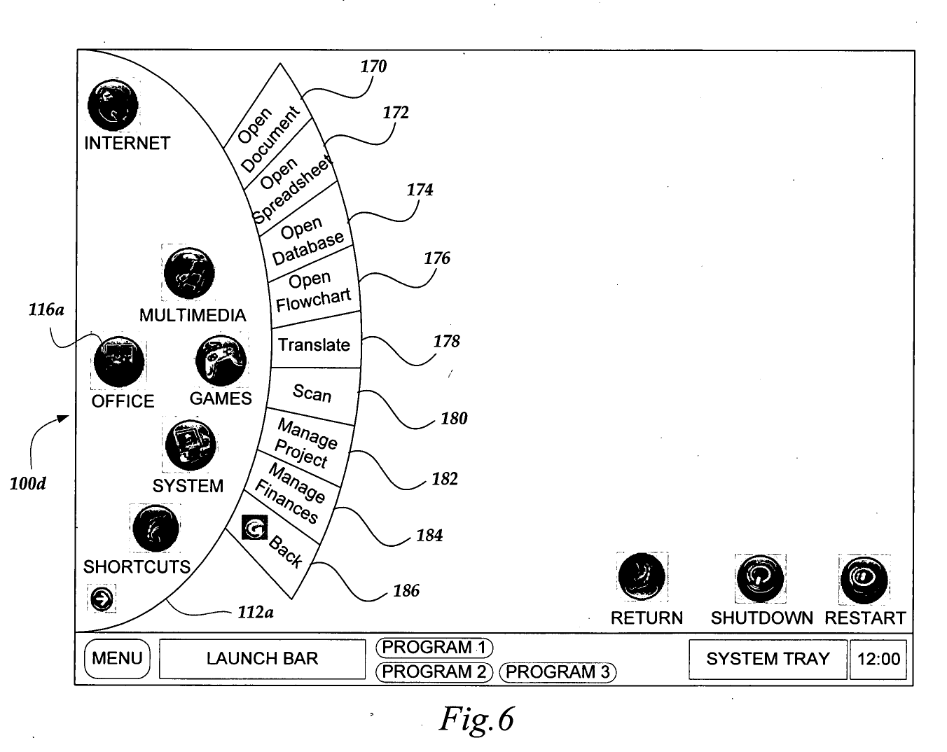

FIG. 6 is a screen print illustrating a desktop environment 100d that displays elliptically fanned tabs 170-186 of software services and/or submenus that are associated with a selected service icon in the exemplary desktop environment of FIG. 5. For example, when a user moves a cursor over office icon 116 shown in FIG. 5, the office icon is moved to the center of an elliptical menu background 112a, as shown in FIG. 6 by office icon 116a. Detection of the cursor over the office icon also causes elliptically fanned tabs 170-186 to be displayed around the perimeter of elliptical menu background 112a. The user can then left click on one of the fanned tabs to initiate a corresponding service. If a fanned tab simply represents a group of services, moving the cursor over that fanned tab will initiate display of an outer level of tabs that represent a submenu of services.

Process Descriptions

Now described are various processes performed by a computing device according to an exemplary embodiment of the invention. The processes and other operations of this exemplary embodiment can be performed in a plurality of sequences in addition to those described below.

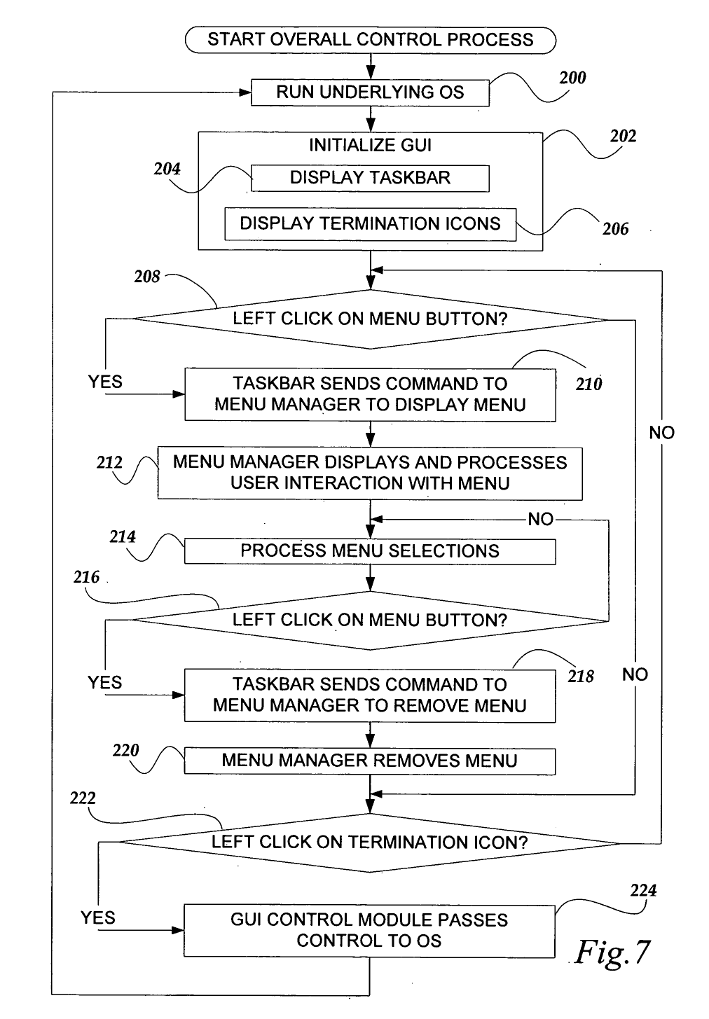

FIG. 7 is a flow diagram illustrating overall logic controlling interaction with a menu according to an exemplary embodiment of the invention. At an operation 200 an underlying operating system is executed, such as Linux™, Microsoft Windows™, and the like. The operating system can be configured to allow manual or automatic initiation of the inventive GUI control module at an operation 202. Initiation includes displaying a taskbar at an operation 204, displaying termination icons at an operation 206, and/or performing other setup processes.

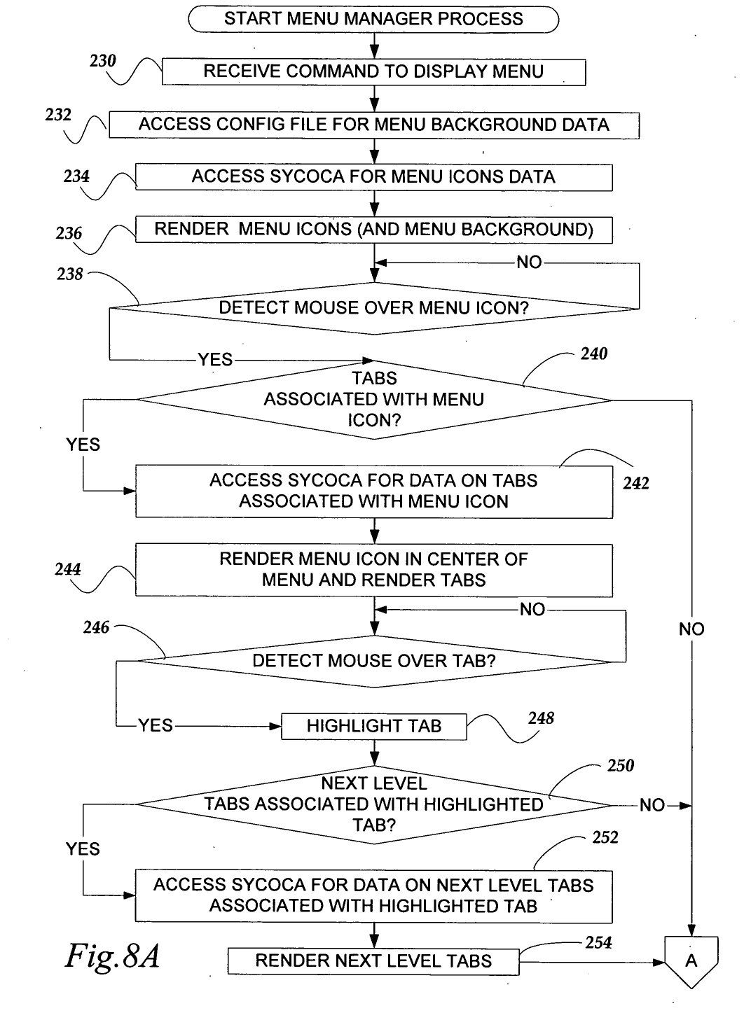

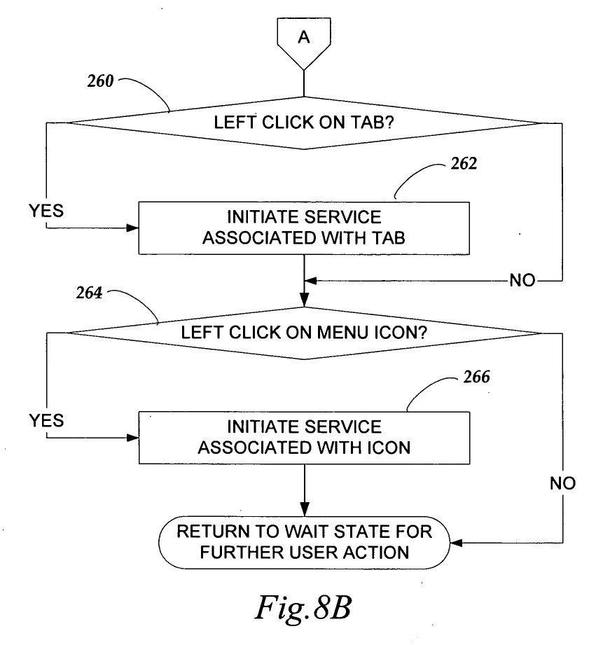

At a decision operation 208, the taskbar module determines whether the user has selected the menu button on the task bar. When the user selects the menu button, the taskbar module sends a command at an operation 210, instructing the menu manager to display the menu. At an operation 212, the menu manager renders the menu with icons, text, background, and/or other graphic characteristics. The menu manager also processes user interaction with the menu such as detecting a cursor over an icon and displaying a set of tabs. At an operation 214, the menu manager processes user selections such as mouse clicks on an icon or tab of the menu. Additional details concerning operations 212 and 214 are discussed with regard to FIG. 8.

The menu manager continues to process user interactions and selections unless the user selects the menu button on the taskbar while the menu is active. If the menu is not currently visible, selecting the menu button causes the GUI to redisplay the menu as described above. However, if the menu is currently displayed and has focus, then selecting the menu button will cause the GUI to remove the menu from display. Specifically, if the taskbar module detects a mouse click on the menu button at a decision operation 216, the taskbar module sends an instruction to the menu manager at an operation 218 to remove the menu from the display at an operation 220.

In one exemplary embodiment, the termination icons are displayed during initialization of the GUI, and remain available in the desktop environment. The termination icons may be displayed in the desktop area or within the menu background if the menu manager is controlling the termination icons. Alternatively, the termination icons may be displayed in the taskbar if the taskbar module is controlling the termination icons. In any case, at a decision operation 222, one of those modules or the GUI control module determines whether the return, shutdown, or restart icon was selected. If none of the termination icons were selected, the GUI control module simple waits for another action, such as selection of the menu button at decision operation 208. However, if one of the termination icons is selected, the control module informs the operating system of the selection and returns control to the operating system at an operation 224.

[Mohamed—please ensure that the following description is accurate. It should be consistent with the description of FIG. 2.] FIGS. 8A and 8B comprise a flow diagram illustrating logic of a menu management process according to an exemplary embodiment of the invention. At an operation 230, the menu manager receives a command from the taskbar module to display the menu. The menu manager accesses the configuration file at an operation 232 for screen coordinates and other graphical data of icons, an optional menu background, and other visual elements. The menu manager also accesses the sycoca at an operation 234 to determine which png files and/or text to be displayed as the service icons in the menu, the termination icons in the desktop environment, and any additional visual elements. (Note that the taskbar module may access the sycoca or an alternate source for data regarding the termination icons if they are to be displayed and controlled through the taskbar.) At an operation 236, the menu manager renders the service icons, the termination icons, and other visual elements.

At a decision operation 238, the menu manager receives an indication, or determines whether the cursor is hovering over a menu service icon (referred to herein as a hovered-over icon). The menu manager then checks the sycoca to determine, at a decision operation 240, whether that hovered-over icon is associated with a submenu of one or more tabs, or is associated with a single data processing service. If the menu service icon is associated with a data processing service, control passes to the logic of FIG. 8B for further processing as illustrated by a connector A. If the menu service icon is associated with a submenu, the menu manager accesses a directory file of the sycoca at an operation 242 to determine the png files, text, and/or other data defining the submenu tabs that are associated with the hovered-over icon. At an operation 244, the menu manager renders the hovered-over icon in the center of the menu and renders the submenu tabs. The rendering can be performed with animation, highlighting, sounds, and/or other effects. For example, the hovered-over icon can be gradually moved from its original position to the center of the menu. The submenu tabs can appear to fan out around the periphery of the menu background in a manner similar to fanning out a set of cards. The submenu tabs need not be visually tied to the menu background. Although the exemplary embodiments illustrated in FIGS. 3-6 show that the menu and submenu tabs are not limited to the areas near the taskbar, the tabs can utilize an even large portion of the desktop environment. For instance, larger tabs can be used for easier visibility by distributing the submenu tabs around the outer edge of the desktop environment.

A similar process is performed when the user moves the cursor over one of the submenu tabs. When the menu manager is notified, or detects at a decision operation 246, that the cursor is hovering over one of the submenu tabs, the menu manager changes the hovered-over tab to appear highlighted at an operation 248. The menu manager then checks the sycoca to determine, at a decision operation 250, whether that hovered-over tab is associated with a next level menu of one or more tabs, or is associated with a single data processing service. If the hovered-over tab is associated with a data processing service, control passes to the logic of FIG. 8B for further processing as illustrated by connector A. If the hovered-over tab is associated with a next level menu, the menu manager accesses a directory file of the sycoca at an operation 252 to determine the png files, text, and/or other data defining the next level tabs that are associated with the highlighted hovered-over tab. At an operation 254, the menu manager renders the next level tabs.

FIG. 8B illustrates exemplary logic for processing a user's selection of an icon or a tab that is associated with a data processing service. At a decision operation 260, the menu manager is notified, or detects that the user has selected a tab. The menu manager then checks a desktop file of the sycoca at an operation 262 to determine a data processing service to perform that is associated with the selected tab. The data processing service can be an application program, access to a system configuration service, access to a communication service, access to an individual data file, and/or other services. Similarly, at a decision operation 264, the menu manager is notified, or detects that the user has selected a menu service icon, a termination icon, the menu arrow icon, or other visual element that is associated with a service. The menu manager checks a desktop file of the sycoca at an operation 266 to determine a service to perform that is associated with the selected icon.

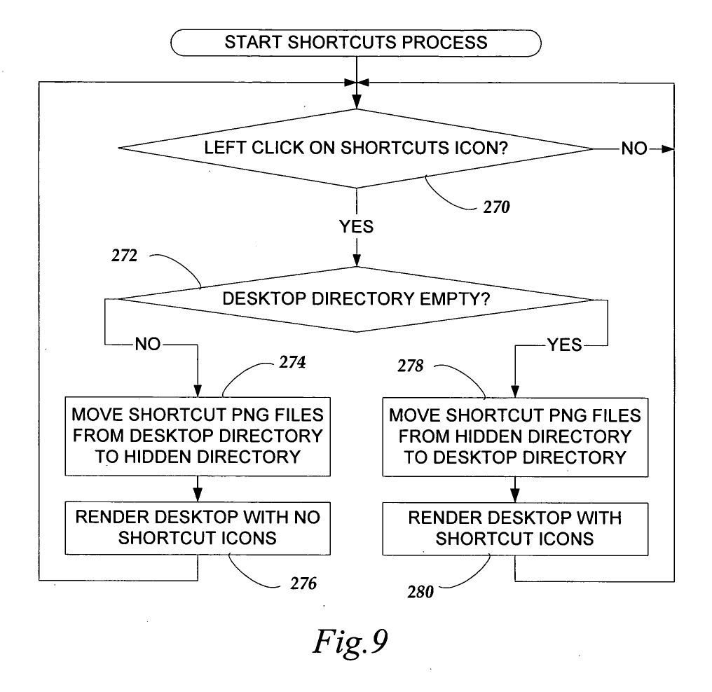

FIG. 9 is a flow diagram illustrating logic for toggling display of shortcuts in the desktop environment according to an exemplary embodiment of the invention. At a decision operation 270, the menu manager is notified or detects that the user has selected the shortcuts icon. The menu manager then determines, at a decision operation 272, whether a desktop directory is empty. An empty desktop directory indicates that no shortcuts are displayed in the desktop area, and the user wishes to display the shortcuts in the desktop area. Conversely, a non-empty desktop directory indicates that shortcuts are already displayed in the desktop area, and the user wishes to remove the shortcuts from the desktop area. Those skilled in the art will recognize that a lookup table or other technique can be used to determine whether shortcuts are currently displayed in the desktop environment.

In this exemplary embodiment, if the desktop directory is not empty, the menu manager moves shortcut png files from the desktop directory to a hidden directory at an operation 274. The menu manager then instructs the computing device to refresh the display at an operation 276, which causes the desktop environment to be displayed without any shortcut icons. In contrast, if the desktop directory is empty, the menu manager moves any stored shortcut png files from the hidden directory to the desktop directory at an operation 278. The menu manager then instructs the computing device to refresh the display at an operation 280, which causes the desktop environment to be displayed with shortcut icons.

The above specification, examples, and data provide a complete description of the manufacture and use of the composition of the invention. For example, the graphical user interface described above can be used for application program menus, so that the menu is independent of a rectangular menu toolbar. Since many embodiments of the invention can be made without departing from the spirit and scope of the invention, the invention resides in the claims hereinafter appended.

What is claimed as new and desired to be protected by Letters Patent of the United States is:

1. A method for providing a graphical user interface (GUI), comprising:
detecting selection of a graphical button displayed within a taskbar, wherein the graphical button enables a user to access a plurality of services of a computer desktop environment; and
displaying a menu of the services in a display area that is visually independent of the taskbar.

2. The method of claim 1, wherein displaying the menu comprises displaying the menu in one of:
a central portion of the display area; and
a side portion of the display area that is not occupied by the taskbar.

3. The method of claim 1, further comprising enabling a user to drag the menu to any location in the display area.

4. The method of claim 1, wherein the menu comprises at least one of an icon and a text description for least one of:
initiating execution of an application program upon selection of the at least one of the icon and the text description;
accessing data upon selection of the at least one of the icon and the text description; and
accessing a next level of the menu upon detection of a cursor over the at least one of the icon and the text description.

5. The method of claim 4, wherein the at least one of the icon and the text description are arranged within a background area.

6. The method of claim 5, wherein the background area is one of a circular background and an elliptical background.

7. The method of claim 5, further comprising:
detecting a cursor over the at least one of the icon and the text description, which corresponds to the next level of the menu; and
displaying the next level of the menu as at least one tab located at a periphery of the background area.

8. The method of claim 7, wherein the at least one tab includes at least one of a tab icon and a tab text description for at least one of:
initiating execution of an application program upon selection of the at least one of the tab icon and the tab text description;
accessing data upon selection of the at least one of the tab icon and the tab text description; and
accessing a further level of the menu upon detection of a cursor over the at least one of the tab icon and the tab text description.

9. The method of claim 1, further comprising:
detecting selection of a shortcut option from the menu;
moving all desktop shortcuts from a desktop directory to a temporary directory; and
removing all shortcut icons from the display area that is visually independent of the taskbar, wherein each shortcut icon is associated with a desktop shortcut.

10. The method of claim 1, further comprising:
detecting selection of a shortcut option from the menu;
moving all desktop shortcuts from a temporary directory to a desktop directory; and
displaying all shortcut icons in the display area that is visually independent of the taskbar, wherein each shortcut icon is associated with a desktop shortcut.

11. A machine readable medium storing machine instructions that cause a processor to perform the operations of claim 1.

12. A system for providing a graphical user interface (GUI), comprising:
a processor;
a display in communication with the processor;
an input device in communication with the processor and enabling a user to control a cursor and select graphical elements displayed in the display; and
a memory in communication with the processor and storing machine instructions that cause the processor to perform the operations of:
detecting selection of a graphical button displayed within a taskbar, wherein the graphical button enables a user to access a plurality of services of a computer desktop environment; and
displaying a menu of the services in a display area that is visually independent of the taskbar.

13. The system of claim 12, wherein the machine instructions further cause the processor to perform the operation of displaying the menu in one of:
a central portion of the display area; and
a side portion of the display area that is not occupied by the taskbar.

14. The system of claim 12, wherein the machine instructions further cause the processor to perform the operation of enabling a user to drag the menu to any location in the display area.

15. The system of claim 12, wherein the machine instructions further cause the processor to perform the operation of displaying in the menu at least one of an icon and a text description for least one of:
initiating execution of an application program upon selection of the at least one of the icon and the text description;
accessing data upon selection of the at least one of the icon and the text description; and
accessing a next level of the menu upon detection of a cursor over the at least one of the icon and the text description.

16. The system of claim 15, wherein the machine instructions further cause the processor to perform the operation of arranging the at least one of the icon and the text description within a background area.

17. The system of claim 16, wherein the machine instructions further cause the processor to perform the operations of:
detecting a cursor over the at least one of the icon and the text description, which corresponds to the next level of the menu; and
displaying the next level of the menu as at least one tab located at a periphery of the background area.

18. The system of claim 17, wherein the machine instructions further cause the processor to perform the operation of displaying in the tab at least one of a tab icon and a tab text description for at least one of:
initiating execution of an application program upon selection of the at least one of the tab icon and the tab text description;
accessing data upon selection of the at least one of the tab icon and the tab text description; and
accessing a further level of the menu upon detection of a cursor over the at least one of the tab icon and the tab text description.

19. A method for toggling access to a desktop shortcut in a computer desktop graphical user interface (GUI), comprising:
detecting selection of a shortcut option in the computer desktop GUI;
moving the desktop shortcut from a desktop directory to a temporary directory; and
removing the shortcut icon from a display area of the computer desktop GUI, wherein the shortcut icon is associated with the desktop shortcut.

20. The method of claim 19, further comprising: detecting selection of the shortcut option in the computer desktop GUI;
moving the desktop shortcut from the temporary directory to the desktop directory; and
displaying the desktop shortcut icon in the display area.
